(19) United States
(12) Patent Application Publication
(10) Pub. No.: US 2017/0168813 A1
(43) Pub. Date: Jun. 15, 2017

(54) Resource Provider SDK

(71) Applicant: Microsoft Technology Licensing, LLC., Redmond, WA (US)

(72) Inventors: Vladimir Pogrebinsky, Redmond, WA (US); Nicholas Harris, Bellevue, WA (US); Shriram Natarajan, Redmond, WA (US); Roger Sprague, Kirkland, WA (US); Florin Bejinaru, Bellevue, WA (US)

(73) Assignee: Microsoft Technology Licensing, LLC., Redmond, WA (US)

(21) Appl. No.: 15/135,734

(22) Filed: Apr. 22, 2016

Related U.S. Application Data
(60) Provisional application No. 62/266,667, filed on Dec. 13, 2015.

(51) Int. Cl. G06F 9/44; G06F 9/445

(52) U.S. Cl. CPC G06F 8/70; G06F 8/30; G06F 8/60

(57) ABSTRACT

Embodiments provide a library that allows developers to very quickly build and deploy services or resource providers without having to interpret a complex cloud protocol specification. The SDK implements resource storage, automatically handles resource lifecycle, provides appropriate hooks to plug into external systems, facilitates handling of subscription-wide operations, implements complex flows such as moving of resources, enables appropriate security features, and creates necessary endpoints for the developer's service.

### CROSS-REFERENCE TO RELATED APPLICATIONS

This application claims the benefit of the filing date of U.S. Provisional Patent Application No. 62/266,667, which is titled “Resource Provider SDK” and was filed Dec. 13, 2015, the disclosure of which is hereby incorporated by reference herein in its entirety.

### BACKGROUND

Extending clouds typically requires standing up a new web service and integrating it with other cloud-related services. To do this, the service provider must manually follow a specification for implementing such services and run corresponding tests. This tends to be a fairly complex task, since new services often need to listen to a wide range of requests and complex request/response protocols must be followed. This can take significant time to accomplish and often leaves boundary cases that are not fully covered and other problems. As a result, an end user is exposed to inconsistent behaviors across cloud-extending services. This makes it more difficult and more expensive to consume such services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments provide a library that allows developers to very quickly build and deploy services or resource providers without having to interpret a complex cloud protocol specification. The SDK implements resource storage, automatically handles resource lifecycle, provides appropriate hooks to plug into external systems, facilitates handling of subscription-wide operations, implements complex flows such as moving of resources, enables appropriate security features, and creates necessary endpoints for the developer's service.

### DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a high level block diagram of a system that provides enterprise users with access to local, on-premises resources and to remote or public resources.

FIG. 2 is a block diagram of a datacenter that provides cloud computing services or distributed computing services according to one embodiment.

FIG. 3 is a high level block diagram of a system for managing cloud services using an SDK.

### DETAILED DESCRIPTION

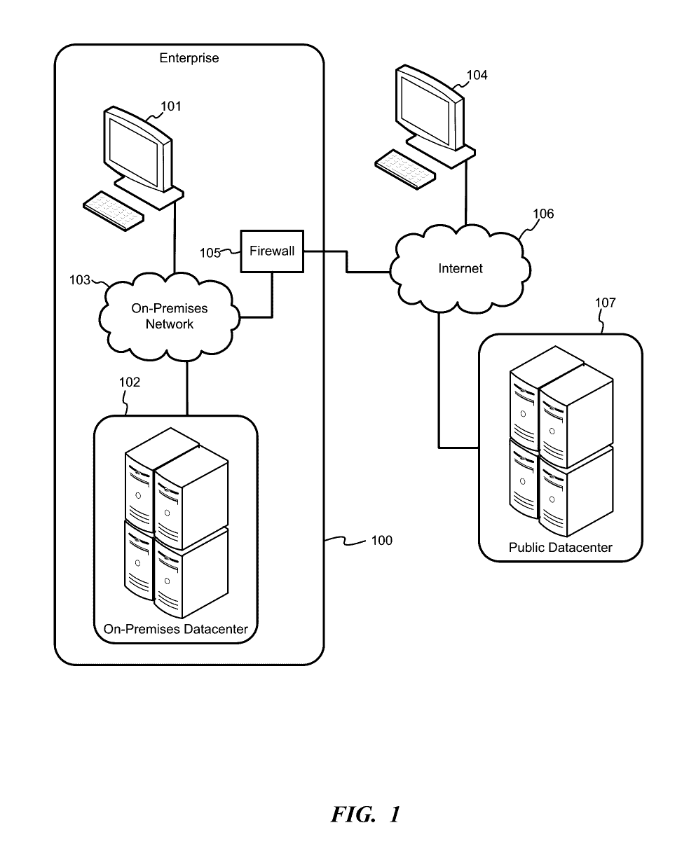

FIG. 1 is a high level block diagram of a system that provides enterprise users with access to local, on-premises resources and to remote or public resources. Local enterprise terminal 101 allows users to directly access on-premises datacenter (private cloud) 102 via on-premises network 103. Users located outside enterprise 100 may access on-premises datacenter 102 using remote terminal 104. Terminals 101 and 104 may be, for example, a desktop, laptop, notebook, or tablet computer. Other devices, such as dedicated terminals, smartphones, personal digital assistants (PDA), etc. may also be used as terminals 101 and 104. Developers may use the terminals 101, 104 to develop and deploy services on private cloud 102 and/or public cloud 107 using a resource provider SDK as described herein.

Firewall 105 provides network security system for enterprise 100 and controls incoming and outgoing network traffic. External terminal 104 may connect to enterprise on-premises network 103 via Internet 106 or any public or private network. Firewall 105 allows terminal 104 to access on-premises datacenter (private cloud) 102 if terminal 104 provides the appropriate credentials and authentication. Enterprise users at terminals 101 and 104 may also access public datacenter (public cloud) 107 via Internet 106.

On-premises datacenter 102 and public datacenter 107 may provide “cloud computing” services to enterprise 100 and other users. By freeing enterprise users from managing information technology (IT) infrastructure, cloud computing provides virtually limitless compute, storage, and network resources at low cost, while allowing services to scale on demand.

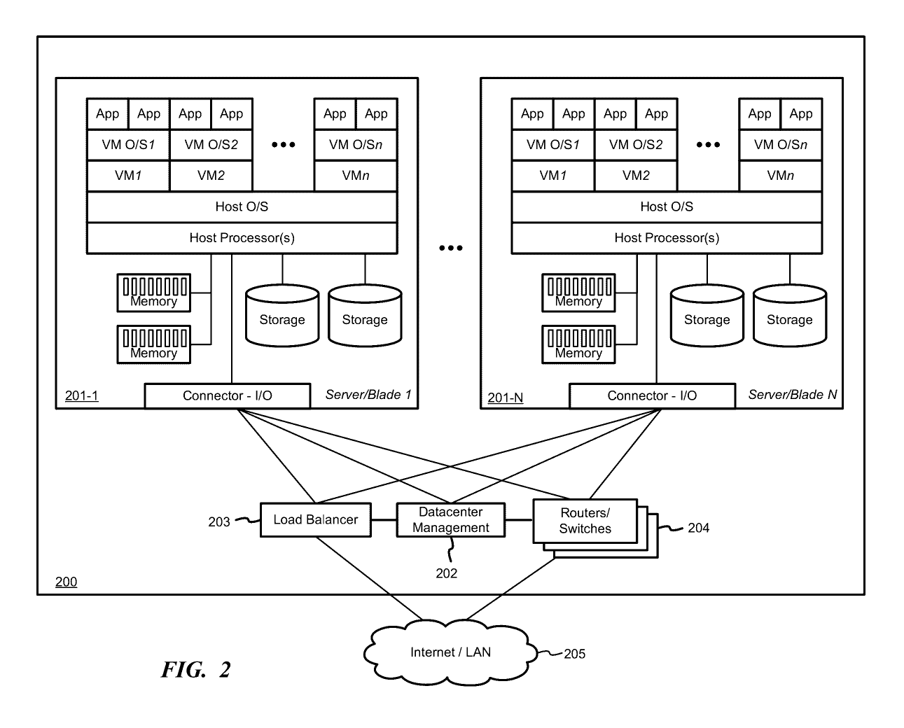

FIG. 2 is a block diagram of a datacenter 200 that provides cloud computing services or distributed computing services according to one embodiment. A plurality of servers 201 are managed by datacenter management controller 202. Load balancer 203 distributes requests and workloads over servers 201 to avoid a situation where a single server 201 becomes overwhelmed and to maximize available capacity and performance of the resources in datacenter 200. Routers/switches 204 support data traffic between servers 201 and between datacenter 200 and external resources and users via external network 205, which may be a local area network (LAN) in the case of an enterprise, on-premises datacenter 102 or the Internet in the case of a public datacenter (107).

Servers 201 may be traditional standalone computing devices and/or they may be configured as individual blades in a rack of many server devices. Servers 201 have an input/output (I/O) connector that manages communication with other database entities. One or more host processors on each server 201 run a host operating system (O/S) that supports multiple virtual machines (VM). Each VM may run its own O/S so that each VM O/S on a server is different, or the same, or a mix of both. The VM O/S's may be, for example, different versions of the same O/S (e.g., different VMs running different current and legacy versions of the Windows® operating system). In addition, or alternatively, the VM O/S's may be provided by different manufacturers (e.g., some VMs running the Windows® operating system, while others VMs run the Linux® operating system). Each VM may then run one or more applications (App). Each server also includes storage (e.g., hard disk drives (HDD)) and memory (e.g., RAM) that can be accessed and used by the host processors and VMs.

Cloud computing is the delivery of computing capabilities as a service, making access to IT resources like compute power, networking and storage as available as water from a faucet. As with any utility, users generally only pay for what they use with cloud computing. By tapping into cloud services, users can harness the power of massive data centers without having to build, manage or maintain costly, complex IT building blocks. With the cloud, much of the complexity of IT is abstracted away, letting users focus just on the infrastructure, data and application development that really matter to their business.

Datacenter or distributed computing network 200 provides pooled resources on which customers or tenants can dynamically provision and scale applications as needed without having to add more servers or additional networking. This allows tenants to obtain the computing resources they need without having to procure, provision, and manage infrastructure on a per-application, ad-hoc basis. A cloud computing datacenter 200 allows tenants to scale up or scale down resources dynamically to meet the current needs of their business. Additionally, a datacenter operator can provide usage-based services to tenants so that they pay for only the resources they use, when they need to use them. For example, a tenant may initially use one VM on server 201-1 to run their applications. When demand increases, the datacenter may activate additional VMs on the same server and/or on a new server 201-N as needed. These additional VMs can be deactivated if demand later drops.

Datacenter 200 may offer guaranteed availability, disaster recovery, and back-up services. For example, the datacenter may designate one VM on server 201-1 as the primary location for the tenant's application and may activate a second VM on the same or different server as a standby or back-up in case the first VM or server 201-1 fails. Database manager 202 automatically shifts incoming user requests from the primary VM to the back-up VM without requiring tenant intervention. Although datacenter 200 is illustrated as a single location, it will be understood that servers 201 may be distributed to multiple locations across the globe to provide additional redundancy and disaster recovery capabilities.

The datacenter operator may offer different levels of cloud computing services to tenants. With an Infrastructure-as-a-Service (IaaS) offering, the lower levels of the IT stack are delivered as a service, which frees up developers from much of the complexity of provisioning physical machines and configuring networks. With IaaS, tenants can easily provision virtual machines in a highly scalable and available cloud environment, develop and test solutions, then deploy applications to production. With a Platform-as-a-Service (PaaS) offering, everything from network connectivity through the runtime is provided. PaaS makes development easy by providing additional support for application services and management of the operating system, including updates. With PaaS, tenants can focus on the business logic of application and quickly move applications from concept to launch. With a Software-as-a-Service (SaaS) offering, a single finished application or suite of applications can be delivered to customers through a web browser, thereby eliminating their need to manage the underlying components of the IT stack including application code.

Referring again to FIG. 1, an enterprise may use a public datacenter or public cloud computing services to take advantage of cost savings, reduced management requirements, or particular services offered. On the other hand, the enterprise may also use an on-premises datacenter or private cloud services to ensure data security or to use a proprietary application, for example. It will be understood that an enterprise does not have to use an on-premises datacenter to take advantage of private cloud services. Instead, private cloud services may be provided by a datacenter that limits access to the enterprise. The use of both public cloud services and private cloud services by an enterprise is referred to generally as a hybrid cloud.

Embodiments provide a library that allows developers to build services of a particular type (e.g., resource providers or cloud services) very quickly. Instead of manually parsing and interpreting a fairly complex specification for a cloud service, developers can use the software development kit (SDK) to very quickly do the following:

1. Comprehensive implementation of resource storage that meets any requirements that are necessary to implement the service specification requirements. These requirements may include, for example, locking, duplicate management, ETag (entity tag) management, and storage partitioning.

2. Automatic handling of resource lifecycle and providing appropriate “hooks” to plug into external systems. For example, this would prevent creation of duplicate resources when processing concurrent creation requests, validations, numerous error and boundary conditions, ETag management, etc.

3. Facilitate handling of subscription-wide operations, such as suspending all resources when a subscription is suspended.

4. Implement complex flows, such as the moving of resources. This supports complex resource operations where multiple resources are involved and where some coordination is required. The operation needs to be idempotent, so that it can be retried. For scale reasons, this can be a complex algorithm when resource storage is partitioned and changes across partition boundaries are not transactional.

5. Provisions to enable appropriate security features, including authentication handlers to facilitate basic authentication, windows authentication, and certificate-based authentication, encryption tools, and the like.

6. Standing up necessary endpoints based on configuration.

7. Provide the ability for developers of resource provider services to register and test unfinished, non-yet-compliant services ahead of certification in order to simplify development of such services.

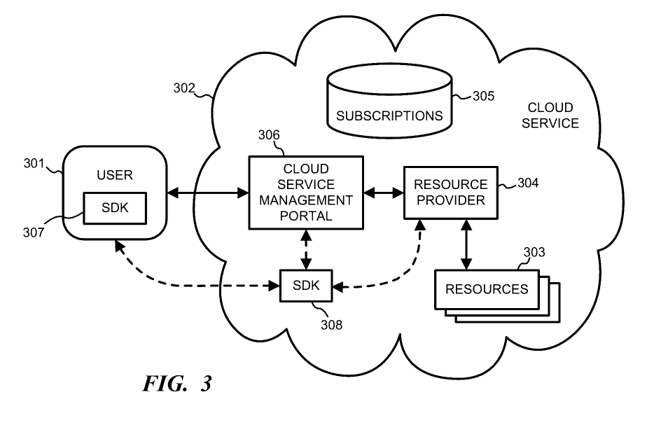

FIG. 3 is a high level block diagram of a system for managing cloud services using an SDK. A user 301 registers with a cloud service 302 to access a number of resources 303. The user 301, who may be referred to as a cloud service tenant, may be an individual or an entity, such as a business or other enterprise that allows employees to access cloud service 302. The cloud service 302 may be a public or private cloud, such as 102, 107 (FIG. 1), or a datacenter or distributed computing network 200 (FIG. 2). Resource provider 304 is a services that provides resources 303 for applications running in the cloud environment 302. The resources 303 may be, for example, a website, virtual machine, database, storage, or other service or functionality needed by user 301. In the simplified drawing only one resource provider 304 and one type of resource 303 is shown; however, it will be understood that cloud service 302 would comprise many different types of resource providers providing many different types of resources. User 301 has a subscription that defines what resources 303 and resource providers 304 the user can access. Subscription data is stored in memory 305.

The subscription for user 301 must be registered with a resource provider 304 before the user's applications can start using the resources 303 provided by the resource provider 304. In one embodiment, resource provider 304 is implemented as an HTTPS RESTful API so that a trusted cloud environment endpoint can provision, delete, and manage services and resources 303 on behalf of user 301. The resource provider API may use verbs such as GET, PUT, and DELETE, to manage resources 303. The lifecycle of each resource 303 is managed by resource provider 304 from creation through deletion. User 301 interacts directly with cloud service 302 through management portal 306. Alternatively, user 301 may interact with management portal 306 using scripts, command-line tools, or a package manager. Management portal 306, in turn, communicates with resource provider(s) 304 to manage the user's service.

In one embodiment, a resource provider SDK 307 implements a protocol handler for resource providers 304 in cloud service 302. SDK 307 may be an application or service running locally at user 301. Alternatively, SDK 308 may be hosted on cloud service 302 and may be accessed remotely by user 301. An SDK 308 hosted on cloud service 302 may operate as a management portal and provide direct access to resource providers 304.

The SDK provides:

a. Standing up web service request handlers based on specified configuration values. A developer or user provides configuration values for a desired service, and the SDK configures the service.

b. A generic storage abstraction layer for resource management over both transactional and non-transactional back ends. The storage abstraction layer is designed to handle a plurality of resource types and behaviors generically without requiring a deeper understanding of corresponding business logic. More specifically, operations, such as CRUD (create, read, update and delete) on resource objects, support for long running operations results, subscription lifecycle, and quota management, are supported. Storage is provided for any domain or resource, such as virtual machines, databases, websites, etc.

c. Storage access partitioned for high scale and provides safe handling for concurrent access to data (using techniques such as locking, queuing and ETags). Different partitions are deployed on different servers to minimize bottlenecks and to provide a faster response.

d. Resource management scenarios including resource operations, long running operations, subscription lifecycle, quota management, gallery item management, usage, diagnostics and events logging, request tracing, security and manifests management.

e. High-density deployment of services. For example, different services, such as databases and websites, may be hosted side-by-side in the same server. This allows multiple services to be co-located and hosted (i.e., deployed) together in the same host. Thousands of services may run on one server.

f. Resource moves. An algorithm is provided to move an entire resource tree. In the algorithm, the nodes of the resource tree are set to read-only, a second tree is created in a second location, so that there is a dual existence of the two trees, and then the second resource tree is made active. If the move fails, the original resource tree can be recovered.

g. Ability to side-load a resource provider (i.e., register a resource provider into a single subscription) to enable service development such as “F5 debugging” experiences in a live cloud environment without exposing the service to all users in that cloud. A developer may need to deploy an unfinished service to a public cloud for testing. The SDK allows the service to be registered only in the developer's subscription on the cloud so that no one else on the cloud can see the service.

h. Support versioning for storage, resource entities, manifest, API versions, and resource upgrade scenarios.

i. Compliance with the wire protocols (i.e., provide expected responses for pre-defined classes of requests) including tests covering these scenarios. The SDK ensures that the resource provider understands and responds as expected and performs the actions it is supposed to perform.

j. An out-of-the-box sample resource provider that shows how to consume the SDK capabilities. The sample resource provider demonstrates SDK use and provides an out-of-the-box template with the appropriate cloud stack implementation. Additionally, the SDK provides an example of how to use the templates, such as a generic template templates and/or sample templates for particular services with a list of steps required to implement the template.

k. Build hybrid resource providers that can be deployed into a plurality of compatible clouds (e.g., for public and private cloud services).

The SDK may be provided to users on computer-readable media, which includes any available media that can be accessed by the user and includes both volatile and nonvolatile media, and removable and non-removable media, but excludes propagated signals. By way of example, and not limitation, computer-readable media may comprise hardware storage media. Computer or hardware storage media includes volatile and nonvolatile, removable and non-removable media implemented in any method or technology for storage of information such as computer-readable instructions, data structures, program modules or other data. Hardware storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the user.

An example computer system comprises: one or more hardware storage media having stored thereon computer-executable instructions; one or more hardware processors that, when executing the computer-executable instructions, access resources on a cloud system and are configured to: interact with resource providers on the cloud system to create resources required to support a service on the cloud system; and provide a software developer kit (SDK) that allows a user to deploy the services on the cloud system.

In an alternative embodiment of the computer system, the SDK implements required resource storage on the cloud system to implement the service.

In an alternative embodiment of the computer system, the SDK automatically handles resource lifecycle and provides any required connections to systems external to the cloud system.

In an alternative embodiment of the computer system, the SDK handles all operations supported by a users' cloud system subscription.

In an alternative embodiment of the computer system, the SDK coordinates operations between two or more resources to deploy the service.

In an alternative embodiment of the computer system, the SDK enables security features on the cloud system using authentication.

In an alternative embodiment of the computer system, the SDK configures endpoints on the cloud system as needed based on a configuration of the deployed service.

In an alternative embodiment of the computer system, the SDK allows users to register and test unfinished or uncertified services on the cloud system.

In an alternative embodiment of the computer system, the SDK configures web service request handlers based on user specified configuration values.

In an alternative embodiment of the computer system, the SDK provides a generic storage abstraction layer for use by the resources supporting the service being deployed.

In an alternative embodiment of the computer system, the SDK provides partitioned storage access and supports concurrent high-speed access to data across the partitioned storage.

In an alternative embodiment of the computer system, the SDK manages the resources created to support the service being deployed.

In an alternative embodiment of the computer system, the SDK provides high-density deployment of services and supports multiple services that are deployed together in a single host in the cloud system.

In an alternative embodiment of the computer system, the SDK performs resource moves by: setting nodes of a resource tree in a first location on the cloud system to read-only; creating a second resource tree in a second location on the cloud system, wherein nodes on the second resource tree correspond to the nodes on the first resource tree; activating the second resource tree; and deleting the first resource tree after confirming that the second resource tree is active.

In an alternative embodiment of the computer system, the SDK is capable of loading a resource provider under development on the cloud system for evaluation without exposing the resource provider under development to other users on the cloud service.

In an alternative embodiment of the computer system, the SDK provides an out-of-the-box sample that demonstrates how users can access capabilities of the SDK.

In an alternative embodiment of the computer system, the SDK provides hybrid resource providers that can be deployed into a plurality of compatible cloud systems.

Another example computer system comprises one or more hardware storage media having stored thereon computer-executable instructions; one or more hardware processors that, when executing the computer-executable instructions, access resources on a cloud system and are configured to: provide a software developer kit (SDK) that allows a user to deploy a service on the cloud system, wherein the SDK provides connections into external systems to support the service, provides a generic storage abstraction layer to support resources required by the service, provides the capability to load a resource provider under development on the cloud system for evaluation without exposing the resource provider under development to other users on the cloud service, provides an out-of-the-box sample that demonstrates how users can access capabilities of the SDK, and provides hybrid resource providers that can be deployed into a plurality of compatible cloud systems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer system, comprising:
one or more hardware storage media having stored thereon computer-executable instructions;
one or more hardware processors that, when executing the computer-executable instructions, access resources on a cloud system and are configured to:
interact with resource providers on the cloud system to create resources required to support a service on the cloud system; and
provide a software developer kit (SDK) that allows a user to deploy the services on the cloud system.

2. The computer system of claim 1, wherein the SDK implements required resource storage on the cloud system to implement the service.

3. The computer system of claim 1, wherein the SDK automatically handles resource lifecycle and provides any required connections to systems external to the cloud system.

4. The computer system of claim 1, wherein the SDK handles all operations supported by a users' cloud system subscription.

5. The computer system of claim 1, wherein the SDK coordinates operations between two or more resources to deploy the service.

6. The computer system of claim 1, wherein the SDK enables security features on the cloud system using authentication.

7. The computer system of claim 1, wherein the SDK configures endpoints on the cloud system as needed based on a configuration of the deployed service.

8. The computer system of claim 1, wherein the SDK allows users to register and test unfinished or uncertified services on the cloud system.

9. The computer system of claim 1, wherein the SDK configures web service request handlers based on user specified configuration values.

10. The computer system of claim 1, wherein the SDK provides a generic storage abstraction layer for use by the resources supporting the service being deployed.

11. The computer system of claim 1, wherein the SDK provides partitioned storage access and supports concurrent high-speed access to data across the partitioned storage.

12. The computer system of claim 1, wherein the SDK manages the resources created to support the service being deployed.

13. The computer system of claim 1, wherein the SDK provides high-density deployment of services and supports multiple services that are deployed together in a single host in the cloud system.

14. The computer system of claim 1, wherein the SDK performs resource moves by:
setting nodes of a resource tree in a first location on the cloud system to read-only;
creating a second resource tree in a second location on the cloud system, wherein nodes on the second resource tree correspond to the nodes on the first resource tree;
activating the second resource tree; and
deleting the first resource tree after confirming that the second resource tree is active.

15. The computer system of claim 1, wherein the SDK is capable of loading a resource provider under development on the cloud system for evaluation without exposing the resource provider under development to other users on the cloud service.

16. The computer system of claim 1, wherein the SDK provides an out-of-the-box sample that demonstrates how users can access capabilities of the SDK.

17. The computer system of claim 1, wherein the SDK provides hybrid resource providers that can be deployed into a plurality of compatible cloud systems.

18. A computer system, comprising:
one or more hardware storage media having stored thereon computer-executable instructions;
one or more hardware processors that, when executing the computer-executable instructions, access resources on a cloud system and are configured to:
provide a software developer kit (SDK) that allows a user to deploy a service on the cloud system, wherein the SDK provides connections into external systems to support the service, provides a generic storage abstraction layer to support resources required by the service, provides the capability to load a resource provider under development on the cloud system for evaluation without exposing the resource provider under development to other users on the cloud service, provides an out-of-the-box sample that demonstrates how users can access capabilities of the SDK, and provides hybrid resource providers that can be deployed into a plurality of compatible cloud systems.
